(19) United States
(12) Patent Application Publication
(10) Pub. No.: US 2008/0225012 A1
(43) Pub. Date: Sep. 18, 2008

(54) Touch frame interface

(76) Inventor: G. Jack Lipovski, Austin, TX (US)

Correspondence Address: Gerald John (Jack) Lipovski, 15017 Calaveras Drive, Austin, TX, 78717, US

(21) Appl. No.: 11/725,212

(22) Filed: Mar. 16, 2007

(51) Int. Cl. G06F 3/041

(52) U.S. Cl. 345/173

(57) ABSTRACT

A plurality of switches are disposed about the periphery of a display. The switches input information from a user to a controlled electronic device. By pressing down on any point of the periphery of the display, two switches disposed at the corners adjacent to the pressed side are operated. A cursor, responsively coupled to the switches, moves towards the frame side that is pressed. Alternatively, displayed text can be made to move away from the side that is pressed. Further, by pressing down simultaneously on two points disposed on opposite sides of the display, a display item that is associated with the present cursor position is selected.

### FIELD OF THE INVENTION

The present invention relates generally to systems, methods and apparatus for man-machine interfaces, and more particularly to interfaces used to navigate displays, such as monitors, liquid crystal displays (LCD), plasma screens, etc.

### DESCRIPTION OF THE PRIOR ART

A user interface is a means by which a person interacts with a machine, device, computer program, or other complex tool. For example, automobiles use a steering wheel, a brake pedal, an acceleration pedal, a speedometer, and other items to interact with a driver. More specifically, when referring to computer programs, a user interface refers to graphical, textual, and auditory information the program presents to the user, and the control sequences the user employs to control the program.

Computer user interfaces have greatly evolved since the introduction of the first computers, which required users to input commands, called jobs, on specially printed “punch cards,” and which printed the results of a users job to a simple printer. Typewriter style “qwerty” keyboards were for some time the most common type of interface. Later, a mouse was added, which allowed a user to control a graphical pointer, and make selections naturally without resort to the use of arrow keys. Other systems, in particular video games, have made use of “joysticks,” which comprise a manipulable rod coupled to a plurality of switches, the operation of which indicate the direction the rod is moved.

Another type of interface is the touch screen. Touch screens allow users to directly select elements displayed on a screen using their fingers, or alternatively, through a stylus. Touch screens are intuitive to operate, as users naturally associate the act of touching a graphical element with selecting it. However, the components required to make a touch screen are costly. Further, touch screens require frequent cleaning due to smudging from fingers. The use of a stylus can eliminate this issue, but at the cost of convenience to the user. Furthermore, special coatings can also alleviate the issue smudging a touch screen, but again, at a higher cost to the user.

### OBJECTS OF THE INVENTION

Accordingly, an object of the invention is to provide an interface that accepts input in a manner similar to a touch screen, but with a lower cost.

Another object of the invention is to provide an interface that accepts input in a manner similar to a touch screen, but that also provides the user with tactile feedback similar to that provided by conventional mechanical keys.

Another object of the invention is to provide an interface that accepts input in a manner similar to a touch screen, but that does not require the use of a stylus or special coating to prevent smudging due to handling with human hands.

### SUMMARY OF THE INVENTION

The disclosed apparatus is interface mechanisms for visual displays that operates in a manner that is similar to touch-screen interfaces, but without many of the disadvantages of touch screens. The apparatus incorporates a conventional two-dimensional display such as a rectangular four line, 20-character-per-line LCD display, and a plurality of switches that are disposed about the periphery of this display. The switches are used to input information from a user to the electronic device. By pressing down on any point of the periphery of the display, two switches disposed at the corners adjacent to the side that is pressed are closed. A cursor is responsively coupled to the switches, and is made to move towards the frame side that is pressed. Alternatively, the displayed text can be made to move away from the side that is pressed. Further, by pressing down simultaneously on two points disposed on opposite sides of the display, a display item that is associated with the present cursor position is selected.

This disclosed invention processes the signals obtained from the switches in a different way than standard and conventional switch signals are processed. At a higher level, the method of using this device may include a step in which two opposite sides are simultaneously pressed. At a lower level, the method, used to detect when one side is pressed or two sides are pressed, continues to sample the input signals while it is waiting in a loop that de-races the switch signals. If any switch closes while the program is in this de-racing step, a bit signal will be sent that indicates this closure.

### BRIEF DESCRIPTION OF THE DRAWINGS

Although the characteristic features of this invention will be particularly pointed out in the claims, the invention itself, and the manner in which it may be made and used, may be better understood by referring to the following description taken in connection with the accompanying drawings forming a part hereof, wherein like reference numerals refer to like parts throughout the several views and in which:

FIG. 1 is a perspective view of a touch-frame interface utilizing the disclosed invention.

FIG. 2 is an explosion of one corner of a touch-frame interface utilizing the disclosed invention.

FIG. 3 is a schematic view of an electronic circuit incorporating a touch-frame interface utilizing the disclosed invention.

FIG. 4 shows a waveform produced by operation of a switch disposed within a touch-frame interface utilizing the disclosed invention.

FIG. 5. is a segment of a C program for use with a microprocessor coupled to a touch-frame interface utilizing the disclosed invention, wherein-switches are free of noise and bouncing.

FIG. 6. is a segment of a C program for use with a microprocessor coupled to a touch-frame interface utilizing the disclosed invention, wherein switch signals exhibit noise and bouncing.

### DETAILED DESCRIPTION OF THE ILLUSTRATED EMBODIMENT

A preferred embodiment of the disclosed invention, using a four-line, 20-character-per-line LCD display and a normally open switch coupled to the display at each corner, is discussed first. This is followed by a discussion of other embodiments using different displays.

In this disclosure, a frame may be an edge or side, or part of the perimeter or periphery of the display surface, or a physically separate fixture that surrounds the display. In the first case, the frame does not include the surface. On the surface, the location where pressing occurred may be determined, such as in a touch-screen display, but in the disclosed apparatus, when a frame is pressed, the digital device will only recognize that the frame (edge, side, or part of the perimeter, or periphery) has been pressed. In the second case described above, the display could be firmly mounted and a non-fixed frame around the outside can be pressed to enter information into the device. In such a case, this frame would be considered to be like a conventional picture frame. Preferably, the frame will cover and hide from view all the switches used in this inventive device. Further, in this disclosure, the display may be a Cathode Ray Tube (CRT), Liquid Crystal Display (LCD), LED Display, plasma screen, or other similar character or graphical display device. The shape of the display and frame may be triangular, rectangular, etc. But this polygonal shape must be convex so that pressing one side does not entail pressing a different side. For convenience, this preferred embodiment will refer to the display as a rectangular n-line m-character per line LCD display.

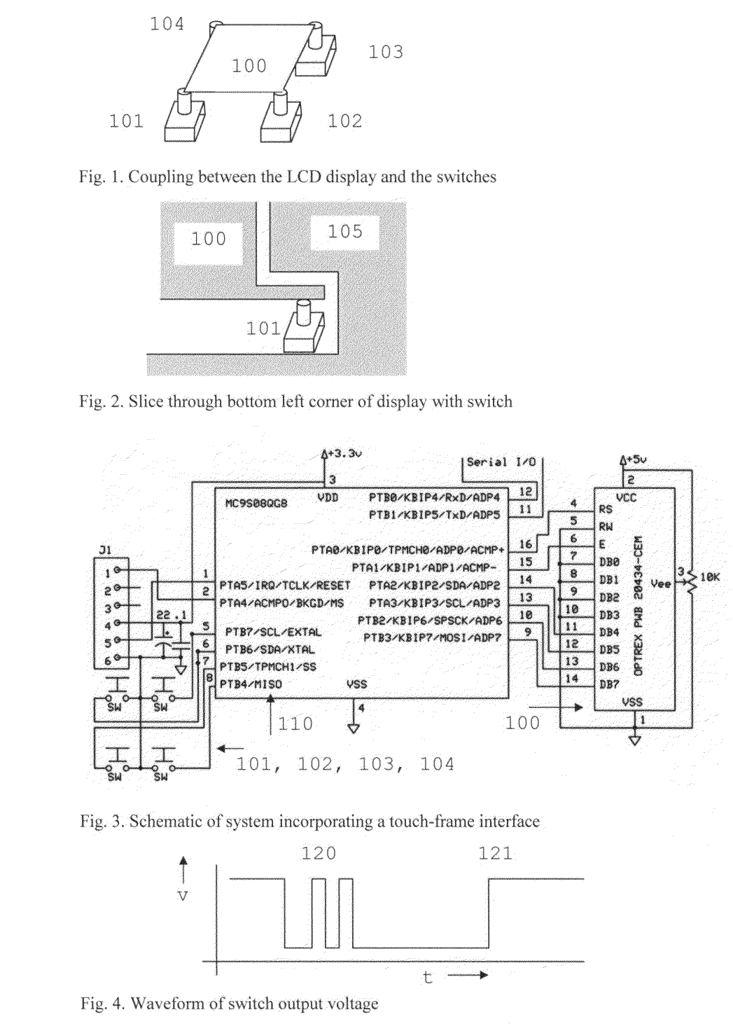

FIG. 1 illustrates the mechanical coupling between the LCD display and the switches. On each corner of LCD display 100 are switches 101, 102, 103, 104. LCD display 100 is enclosed in housing 105 so that it moves freely within a cavity created by this housing, but is constrained so that each corner of the display can push down on the switch coupled to that corner, as seen in FIG. 2.

FIG. 3 is a schematic of a system using a touch-frame interface. A Freescale microcontroller model MC9S08QG8 110, is electrically connected to an Optrex model PWB 20434-CEM four line, 20-character-per-line LCD display 100, and four Omron momentary pushbutton switches (normally open), model B3F-1022, are denoted as 101, 102, 103, and 104. Microcontroller port A is connected to LCD pins RS, E, DB4, and DB5, and serial input/output lines, while microcontroller port B is connected to LCD pins DB6 and DB7, and four pushbutton switches. The MC9S08QG8 User's Manual, MC9S08QG8, Rev 1.01, 10/2005, is available on-line from Freescale, and is incorporated herein by reference. In particular, Chapter 6 describes how parallel port B is configured and used. By asserting port B pull-up enable (PTBPE) bits 7 to 4, port B data pins have a pull-up resistor to power supply voltage Vcc so that if no voltage source drives the pins, the digital signal read from port B (PTBD) bits 7 to 4 will be high, and read as a logical “1” by the program.

Interfacing to switches is explained in more detail in chapter 11 of “Introduction to Microcontrollers”, second edition, 2004, Academic Press, which is authored by the inventor, and is included herein by reference. When a normally-open switch is pressed and then released, whose one side being connected to ground and other side being connected by a pull-up resistor to power supply voltage (Vcc), the voltage on the port B pin will appear as shown in FIG. 4. For a period less than 10 msec. after the switch is pressed, the input voltage can “bounce” a few times, as illustrated by trace section 120. When the switch is released from being pressed, as shown by trace section 121 in the rightmost part of the trace in FIG. 4, this output goes high, without bouncing, and remains high until the switch is pressed again.

In addition to bouncing, switch signals may experience noise. Noise is defined as any part of a measured signal that is not a part of an electronic circuit's intended operation. For instance, when the signal from a switch should be high, it may be made to appear to be low due to noise caused by electromagnetic radiation. A signal is called clean in this specification when the effects of noise and bouncing are eliminated from it.

Finally, systems with switches may race. A race is a condition in which the final output is determined by how long a switch is actuated or pressed. A controlled race is commonly used in keyboard input; for instance, if a user presses and holds down the space key, the number of space characters generated by the keyboard interface is a function of how long the user holds down the space key. Switch interfaces can experience uncontrolled races, with unpredictable results. Eliminating the race condition is known as de-racing.

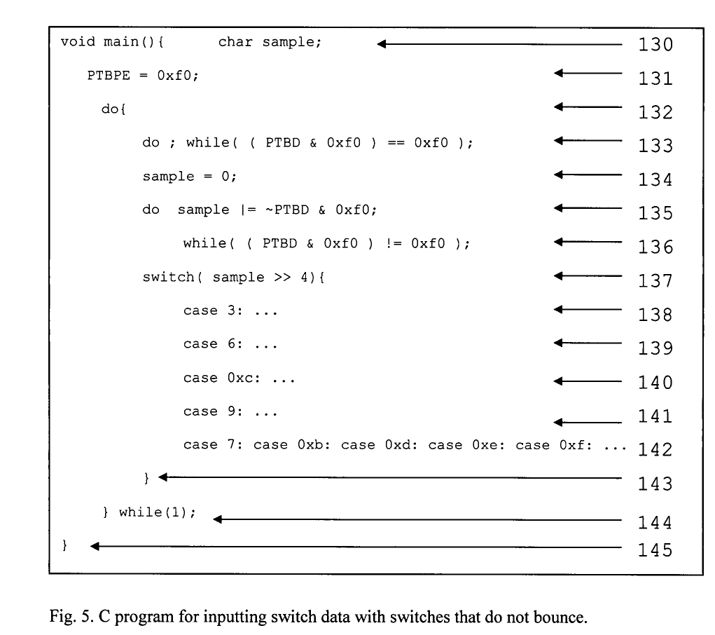

In accordance with one aspect of the disclosed invention, a pseudo-“C” language program to input data from switches arranged in accordance with this invention is shown in FIG. 5. This program does not accommodate bouncing or noise, but can be used with switches that have essentially no bounce, such as Hall Effect switches, provided the switch signals have little or no noise. The program, starting at line 130 and ending at line 145, first declares local variable sample on line 130. Next on line 131 it writes 0xf0 into memory location PTBPE (which is a register that controls the operation of port B in the microcontroller utilized by this program) in order to insert pull-up resistors in port B bits 7 to 4. The program then loops at line 133 as long as all four switches are open and their output signals are input as logical ‘1’. When any switch is closed and its signal falls to a logic ‘0’, then the program will remain in the loop described in lines 135 and 136 as long as any switch is closed and its output voltage is logic ‘0’. During this loop, the bits input from port B are repeatedly read. A bit in variable sample is set if a switch is closed so that its output voltage is low, as shown by line 135.

For further example, the input bits may be connected to port B pins as follows: the switch at the bottom left is connected to port B bit 7, the switch at the bottom right is connected to port B bit 6, the switch at the top right is connected to port B bit 5, and the switch at the top left is connected to port B bit 4, If only two adjacent switches are pressed, then the value of sample >>4 will be 3, 6, 0xc, or 9, and the statements indicated by (non C-language) ellipsis . . . will move the cursor: the value 3 will move the cursor up (line 138), the value 6 will move the cursor right (line 139), the value 0xc will move the cursor down (line 140), the value 9 (line 141), will move the cursor left. For other values resulting from 3 or 4 switches being closed, resulting three or four input bits of sample being ‘1’, specifically 7, 0xb, 0xd, 0xe, and 0xf, (line 142), the application program will carry out what was intended by selecting the item that the cursor is on. Finally, for the values which result from only one bit being closed and then released, the switch statement has no case to go to and defaults to doing nothing, then resuming the first loop. This sequence is repeated in the loop from line 132 to 144, forever.

The example described above illustrates the key idea used in this implementation. The switch signals are conventionally tested until any switch is pressed, while a first-pressed switch remains pressed until all switches are not pressed, pressing other switches and possibly releasing them, in any order and at any time, will set bits in the result generated by the interface and subsequently used by the application program. Note that the loop in lines 135 and 136 deraces the switch signals, but if line 135 is removed from the program, the resulting loop consisting of line 136 still deraces the switch signals. The disclosed system includes the setting of bits of the result during the de-racing step.

We contrast this inventive technique with the use of shift and control keys in computer keyboards. Therein, if a shift or control key is pressed or released therein, no different signals are sent from the switches than are sent if these keys are not pressed. When another key is pressed, the switch signals are processed as in FIG. 5, with an additional step of returning the state of these control and shift keys as they are sampled in line 134. These keys have to be pressed down and held down before the other keys in the keyboard are pressed, so the signal from these keys will be input to the microcontroller. After this step, while the second loop, comprising lines 135 and 136, is executed to de-race the switch, pressing these control or shift keys has no effect on the information sent to the application program. Further, in conventional keyboards that do not practice this invention, the treatment of the signal from these shift and control keys is different from the treatment of the other keys. In the disclosed invention, all four keys are treated in the same manner.

The “press-and-hold” operation used in conventional keyboard controlled racing can be used with the select operation in the preferred embodiment. The controlled race is undone if the select operation is done, by saving, and then restoring, the position or value of the variable affected by this feature if the user does indeed press the opposite side to select the display item.

This modification is most clearly seen by adapting the simple program of FIG. 5 to include a controlled race “press-and-hold” operation that is different from the operation resulting when one side of the frame is briefly pressed. First, the operation of pressing and holding the right side of the frame is discussed in detail, and then the other types are discussed by analogy to the first case. In addition to local variable sample, local variables savedLocation and currentTime are allocated (line 130). During initialization (line 131) the current location of the cursor is saved in variable savedLocation and variable currentTime is cleared. While sampling the input (lines 135 and 136), variable currentTime is incremented each time the loop is executed. When this count reaches a predetermined value and the value sample indicates that the right side of the frame is pressed, the cursor is moved rightward one character position, the display is updated, and currentTime is cleared. This is implemented in FIG. 5 by adding the code to line 135 to increment currentTime, and when it reaches the predetermined value, to clear currentTime, increment the cursor value, and updating the display. Continued holding down of the right side of the frame will repeat this operation, implementing a controlled race. Similarly, holding the left side of the frame will result in the cursor moving leftward, holding the top side of the frame will result in the cursor moving upward, and holding the bottom side of the frame will result in the cursor moving downward. The cursor will move at a pace specified by the predetermined value, in a controlled race.

However, if the user presses the opposite side of the frame, desiring to select the display item, (indicated by being in line 142), and only accidentally moving the cursor in the controlled race, code is appended to line 142 to replace the cursor to its original position, as indicated by the saved variable savedLocation, canceling the effect on the cursor of the controlled race, and responding as if the item is selected.

In summary, if the frame is briefly pressed, the cursor moves one character. If the frame is pressed and held down, the cursor moves multiple characters at a time, in a controlled race, but if during any time the side of the frame is pressed or the opposite side is pressed, the cursor is restored to the position it occupied before any side was pressed, and the “select” operation is executed.

Similarly, an operation like the standard mouse “double click”, where the user presses the same mouse button twice within a short time, can be used with the select operation of this preferred embodiment. As was used in the “press-and-hold” operation, the cursor is moved responsive to each click, but the initial cursor location is saved, and then the cursor location is restored if indeed the user executed a double click operation, and some operation responsive to the double-click is carried out.

Press-and-hold and double-click operations may be used for reversible operations, such as moving the cursor. Select operations should be used for irreversible or mandatory operations that must be done exactly once when requested. An extreme example would be an operation to fire a gun. One cannot reverse the operation, to “unfire” the gun, and it would be unacceptable to not fire the gun when the operation is requested. So such operation should not result from possibly ambiguous press-and-hold or double-click operations, but rather can result from a select operation as described in this invention.

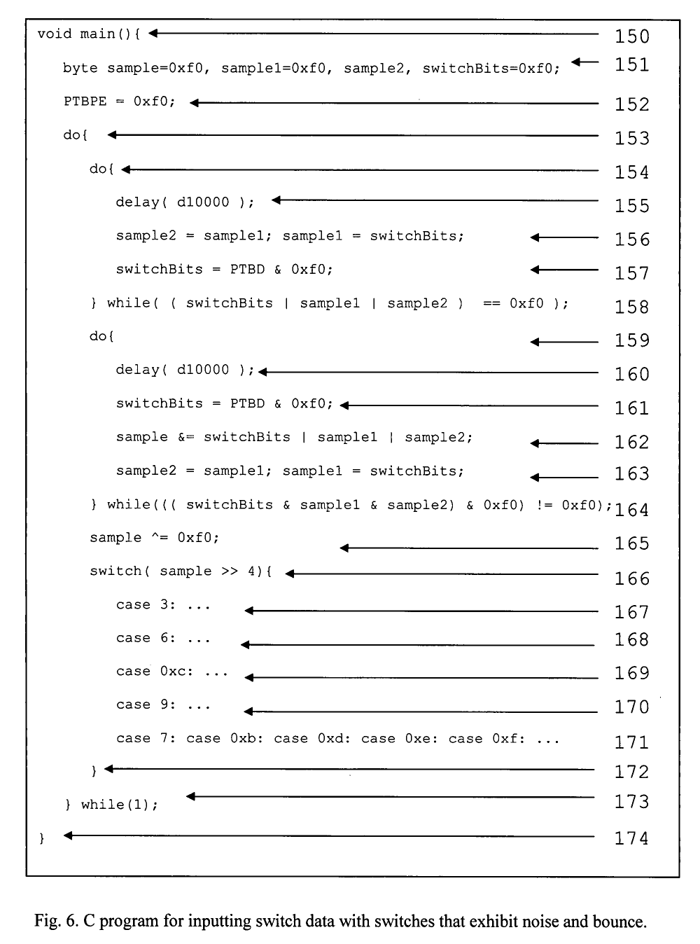

Unfortunately, inexpensive switches are more susceptible to bouncing than switches that can be used in FIG. 5's program. Therefore, a practical implementation is programmed as shown in FIG. 6, which is a pseudo-“C” language program to input data from the switches, which can tolerate noise or bouncing. It first cleans the switch inputs, using the variables sample1, sample2, and switchBits, and then sets the resulting interface output bits wherever corresponding switches were closed.

The program main( ) from lines 150 to 174 contains a declaration of variables in line 151 and a loop from lines 152 to 173, which is repeated forever. As in the previous example, line 152 writes 0xf0 into register PTBPE to in order to insert pull-up resistors in port B bits 7 to 4.

Cleaning is implemented by the loop comprising lines 154 to 158, which functions by waiting until some switch is closed for an adequate amount of time to eliminate bounces and noise from the switch signals. Passing the parameter d10000 to the procedure delay( ) in line 155 makes the procedure wait for 10000 microseconds, so this aforementioned loop is executed once every 10 milliseconds. Each time through the loop, the present input data is stored as variable switchBits in line 157, and previously obtained switch inputs are stored in variables sample1 and sample2. Line 156 implements a trivial “queue” to hold the latter two variables. The aforementioned loop is executed as long as one of the bits in variable switchBits, taken from the corresponding bit in the input port in the present iteration, and sample1, taken from the input port in the immediate past loop iteration, and sample2, taken from the input port, two loop iterations back, are all three ‘0’s. This will not be so if noise or a bounce corrupts the signal. If any switch is pressed and remains pressed during these three sample times, then the while( ) argument in line 158 is false and therefore the loop from lines 154 to 158 is exited, and another loop from lines 159 to 164 is entered. This loop similarly executes one iteration each 10 milliseconds, due to the delay( ) procedure called in line 160. It inputs switch signal values in line 161, and maintains the last two samples in a “queue” in line 163. Bits in variable sample will be cleared to ‘O’ in line 162 if the corresponding bits were cleared in all three variables switchbits, sample1, and sample2, in line 163. This loop is continued in line 164 until all the bits in these three variables are ‘1’ in all four switch signals, indicating all switches have been opened for the last three iterations of the loop shown in lines 159 to 164. After the end of the latter loop, the line 165 inverts the switch bits, and the remaining program in FIG. 6 lines 165 to 172 is the same as the end of the program in FIG. 5, lines 137 to 143.

In the program of FIG. 6, a first step cleans the switch signals, and a second step combines these clean signals to test them for at least two such clean signals to be pressed simultaneously. This last step also accommodates the recognition of when two sides of the frame are pressed simultaneously, to indicate that a value is “selected”.

### Alternate Embodiments

While the switches in the preferred embodiment are at the corners, if the switches are capacitive, Hall Effect, or based on detecting radiation of any kind, then the switches could be placed in the middle of each side rather than the corners. This alternative embodiment has the disadvantage of having to account for ambiguous combinations. In this alternative embodiment, pressing on a corner could result in pressing two switches in the middle of the edges connected to that corner, leaving the program unsure of which edge was pressed. The preferred embodiment does not have an analogous problem; pressing on one corner alone, rather than an edge, will result in the programming detecting and then ignoring the single switch closure. Similarly, in the alternative embodiment, a noise spike on one just of the switch inputs could cause the same result as if the switch was pressed. But in the preferred embodiment, two adjacent switches would have to exhibit a noise pulse at the same time before the electronic device would execute some action that is supposed to be responsive to the pressing of both switches. The preferred embodiment is therefore somewhat more robust in tolerating noise in its switch signals. Further, if the mechanical switches have a tactile element, e.g., a click, then when the preferred embodiment is used, pressing a side will result in two clicks. However, if the application indicates that simple mechanical switches cannot be used, this alternative embodiment could be easier to use than the preferred embodiment using capacitive, Hall Effect, or radiation detecting switches.

Less expensive one-line n-character-per-line displays can be used with some applications, and do not need more than one switch at each end of the short ends of a display. Words like “start”, “accelerate”, “slow”, “stop”, etc. can be written on a single line of text, and part of the line can be displayed in the one-line n-character-per-line display. By moving the cursor or the text, by pressing the left side or the right side an appropriate number of times, the cursor can be placed over the desired word (or the desired word could be placed under the cursor) and the item can be selected by pressing both ends down simultaneously. Alternatively, the one-line display could be fitted with four switches, one at each corner, as in the preferred embodiment. The left and right end switches could be used to move the cursor, while the top and bottom switches could be used to change the value of the character that is under the cursor. For instance, in a variable power supply, the selected output voltage can be displayed on the one-line display, such as 4.289 V. By positioning the cursor over the digit to be changed, for example the digit ‘8’, then pressing the top edge, that digit could be changed to ‘9’, and by pressing the bottom edge, it could be changed to ‘7’. Multiple pressing of the bottom edge could change this digit to ‘6’, and then ‘5’, and pressing and holding the bottom edge would decrement the number in a controlled race, and so on.

More sophisticated displays of images could be adapted to this touch-frame technology. For instance, using red-green glasses as in 3-d movies of some time ago, a three-dimensional image could be displayed. This image could be delivered through a LCD display with red and green pixels, generating two two-dimensional images, one red and the other green, on the surface of the display that are seen through the user's two eyes, through the red and green filters. By pressing on the left and right edges of the two-dimensional display that is used to generate the three-dimensional image, a cursor could move left or right, and by pressing on the top and bottom edges, a cursor could move up or down. To move the cursor forward or backward in the third dimension, the case where two sides are simultaneously depressed cold be further distinguished as to which key was pressed first. For instance if the left edge is pressed and then the right edge is then pressed, the item selected by the cursor could be selected, as in the preferred embodiment discussed earlier, but if the right edge is pressed and then the left edge is then pressed, the cursor could move forward in the third dimension. Further, if the left edge is pressed and the right edge is then pressed, the item selected by the cursor could be selected, as in the preferred embodiment discussed earlier. Further, if the top edge is pressed and the bottom edge is then pressed, the cursor could move back in the third dimension. Such a three-dimensional display might use a hologram to display the output information, and the switches attached to a frame around a hologram generator to input information. A similar kind of useful display could display one of a multiple of two-dimensional sheets. For instance, each sheet might display a blueprint of a multi-storied building, one blueprint per floor. Pressing on the right edge and then the left edge, the cursor could move to a display of the blueprint for a higher floor, and if the top edge is pressed first and the bottom edge is then pressed later, the cursor could be moved down to a display of the blueprint for a lower floor. Once the cursor has navigated to the desired floor, the display could be used as described in the preferred embodiment, provided that the operations that change the selection of the floor blueprint are not used.

The foregoing description of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and various modifications as are suited to the particular use contemplated. It is intended that the scope of the invention not be limited by the specification, but be defined by the claims set forth below.

I claim:

1. An apparatus comprising:
i) an electronic device;
ii) a convex polygonal display having a plurality of corners and coupled to the electronic device; and
iii) a plurality of switches disposed near the corners of said display and coupled to the electronic device, wherein each switch generates a signal that changes when actuated,
wherein the electronic device changes the appearance of the displayed information responsive to the generated signals.

2. The apparatus of claim 1 in which the display is an LCD display.

3. The apparatus of claim 1 in which the switches are disposed beneath the corners of a frame including a plurality of edges coupled to said display so that when an edge of the frame is pressed, a plurality of switches are actuated.

4. The apparatus of claim 1 wherein said display includes a plurality of edges and wherein said switches are disposed beneath the corners of said display so that when an edge of said display is pressed, a plurality of switches are actuated.

5. The apparatus of claim 1, wherein operation of at least two switches simultaneously generates a second signal.

6. The apparatus of claim 3, wherein the frame is a single article.
